(19) United States
(12) Patent Application Publication
(10) Pub. No.: US 2020/0151975 A1
(43) Pub. Date: May 14, 2020

(54) Wireless Control Method and System

(71) Applicant: Wistron NeWeb Corporation, Hsinchu (TW)

(72) Inventors: Feng-Wei Chang, Hsinchu (TW); Yang-Cheng Lin, Hsinchu (TW); Tung-Yu Liu, Hsinchu (TW); Chi-Han Kuo, Hsinchu (TW)

(21) Appl. No.: 16/663,324

(22) Filed: Oct. 24, 2019

(30) Foreign Application Priority Data
Nov. 8, 2018 (TW) 107139686

(51) Int. Cl. G07C 9/00; H04W 76/14

(52) U.S. Cl. CPC G07C 9/00111; G07C 9/00309; B60R 25/24; G07C 2009/00769; B60R 2325/101; H04W 76/14

(57) ABSTRACT

A wireless control method, used for a first device and a second device, includes the second device establishing a wireless communication connection with the first device via a plurality of channels, the first device determining whether the plurality of channels conform to a plurality of predefined channels, and the first device executing a function when the plurality of channels conform to the plurality of predefined channels.

### BACKGROUND OF THE INVENTION

### 1. Field of the Invention

The present invention relates to a wireless control method and a wireless control system, and more particularly, to a wireless control method and a wireless control system utilizing channels of wireless communication connection as authentication credential.

### 2. Description of the Prior Art

With the evolution of wireless technology, wireless control technology has been widely adopted in various access control managements such as vehicle anti-theft devices, home security, company access control and so on. A conventional access control management system utilizes a near-field communication (NFC) technology in which a user carries a radio-frequency identification (RFID) tag and unlocks a door (lock) via electromagnetic induction. However, a sensing distance of the NFC technology is short. The user must put the RFID tag close to a reader device, which inconveniences the user.

Therefore, how to enhance convenience of wireless control while meeting security requirements has become a goal in the industry.

### SUMMARY OF THE INVENTION

It is a primary objective of the present invention to provide a wireless control method and a wireless control system to enhance convenience of wireless control while meeting security requirements.

An embodiment of the present invention discloses a wireless control method for a first device and a second device. The wireless control method includes the second device establishing a wireless communication connection with the first device via a plurality of channels; the first device determining whether the plurality of channels conform to a plurality of predefined channels; and the first device executing a function when the plurality of channels conform to the plurality of predefined channels.

An embodiment of the present invention further discloses a wireless control system including a first device; and a second device; wherein, the second device establishes a wireless communication connection with the first device via a plurality of channels; the first device determines whether the plurality of channels conform to a plurality of predefined channels: and the first device executes a function when the plurality of channels conform to the plurality of predefined channels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless control system according to an embodiment of the present invention.

FIG. 2 is a schematic diagram of a wireless control process according to an embodiment of the present invention.

FIG. 3 is a schematic diagram of a vehicle anti-theft system 30 according to an embodiment of the present invention.

### DETAILED DESCRIPTION

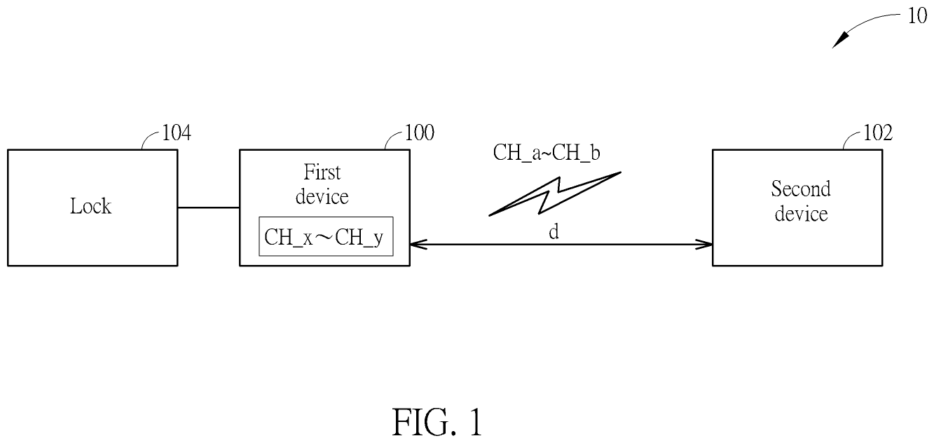

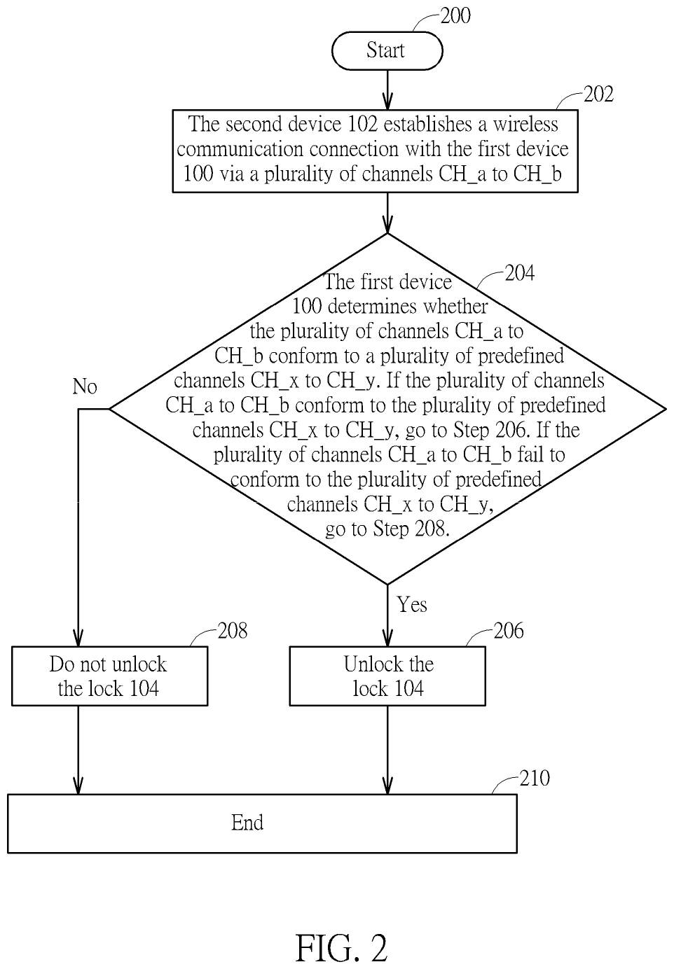

Please refer to FIG. 1, which is a schematic diagram of a wireless control system 10 according to an embodiment of the present invention. In this example, the wireless control system 10 is an access control management system. A first device 100 serves as an access control device and exercises locking and/or unlocking controls of a lock 104. A second device 102 serves as an electronic device with a wireless communication function and is able to establish a wireless communication connection with the first device 100. The first device 100 determines whether to unlock the lock 104 according to channels, which are utilized by the second device 102 for establishing the wireless communication connection. Please refer to FIG. 2 for operations of the wireless control system 10. FIG. 2 is a schematic diagram of a wireless control process 20 according to an embodiment of the present invention. The wireless control process 20 includes following steps:

Step 200: Start.

Step 202: The second device 102 establishes a wireless communication connection with the first device 100 via a plurality of channels CH_a to CH_b.

Step 204: The first device 100 determines whether the plurality of channels CH_a to CH_b conform to a plurality of predefined channels CH_x to CH_y. If the plurality of channels CH_a to CH_b conform to the plurality of predefined channels CH_x to CH_y, go to Step 206. If the plurality of channels CH_a to CH_b fail to conform to the plurality of predefined channels CH_x to CH_y, go to Step 208.

Step 206: Unlock the lock 104.

Step 208: Do not unlock the lock 104.

Step 210: End.

According to the wireless control process 20, when the second device 102 establishes a wireless communication connection with the first device 100 via the channels CH_a to CH_b, the first device 100 determines whether the channels CH_a to CH_b conform to the predefined channels CH_x to CH_y so as to decide whether to unlock the lock 104. The predefined channels CH_x to CH_y are information previously configured and stored in the first device 100. If the second device 102 has already passed verification, the second device 102 would store the same configuration information. In other words, a user may unlock the lock 104 merely by bringing the second device 102 near the first device 100. On the contrary, if the second device 102 does not pass verification in advance, the second device 102 may not acquire related information of the predefined channels CH_x to CH_y. Therefore, the second device 102 is not able to unlock the lock 104. Briefly, in this embodiment, the first device 100 determines whether to unlock the lock 104 according to whether the channels CH_a to CH_b utilized by the second device 102 for establishing the wireless communication connection conform to the predefined channels CH_x to CH_y previously configured.

It is noteworthy that the wireless control process 20 illustrates procedure of the wireless control system 10 performing unlocking, and is merely an embodiment of the present invention. Those skilled in the art may make proper modification according to different systems. For example, in an embodiment, before the second device 102 establishes the wireless communication connection with the first device 100 via the channels CH_a to CH_b according to Step 202, the second device 102 may establish another wireless communication connection with the first device 100 first by means of different channels (namely, channels different from the channels CH_a to CH_b). That is, before the second device 102 utilizes the channels CH_a to CH_b to perform unlocking, the second device 102 may establish wireless communication connection with the first device 100 in advance in order to ensure the unlock procedure to be performed correctly. After the second device 102 finishes the wireless control process 20 and completes unlocking, the second device 102 may keep utilizing the channels CH_a to CH_b to communicate with the first device 100 (for example, data exchange), and may further establish another wireless communication connection with the first device 100 for communication. This is also within the scope of the present invention.

FIG. 1 only shows the first device 100 and the second device 102 of the wireless control system 10. In fact, apart from the first device 100 serving as a main control device, the wireless control system 10 may include a plurality of electronic devices similar to the second device 102 as well. Besides, the first device 100 may perform verification on each electronic device respectively according to the wireless control process 20 to determine whether an electronic device can pass access control. Moreover, in the wireless control system 10, the lock 104 is only an embodiment, and may be an anti-theft system of a vehicle, a door lock of a building, and so on. The present invention is however not limited to these. Control on the lock 104 is only exemplary illustration, and the present invention may be applied in various function control. For example, in one embodiment, the function of unlocking the lock 104 can be replaced with controls on a light or an air conditioner. In other words, when the second device 102 carried by a user approaches and passes verification of the first device 100, the first device 100 may turn on or off a light or an air conditioner. In another embodiment, the function of unlocking the lock 104 may be replaced with a login to a computer system. That is to say, when a user carries the second device 102 and passes verification of the first device 100, the first device 100 may log in a computer system automatically. To be brief, all applications utilizing channels as authentication credential to determine whether to execute a function accordingly are within the scope of the present invention.

In an embodiment, when a distance d between the second device 102 and the first device 100 is less than a predefined value, the second device 102 automatically starts to perform unlocking (namely, taking Step 202); in another embodiment, the second device 102 is controlled by the user to trigger an establishment of the wireless communication connection with the first device 100. For example, the user executes an application in the second device 102 first, and then the second device 102 begins (to establish) the wireless communication connection with the first device 100. In general, the distance d between the second device 102 and the first device 100 is related to strength of wireless signal(s). Therefore, in an embodiment, it may further be configured that the first device 100 starts to determine whether the channels CH_a to CH_b conform to the predefined channels CH_x to CH_y (namely, taking Step 204) only when the distance d is less than a specific value. Comparing whether the distance d is less than a specific value means determining whether signal strengths of the channels CH_a to CH_b are greater than a predefined value. In other words, it may be configured that when the signal strengths of the channels CH_a to CH_b are greater than specific value(s), the first device 100 starts to determine whether the channels CH_a to CH_b conform to the predefined channels CH_x to CH_y (namely, taking Step 204). In this way, the distance d between the second device 102 and the first device 100 would meet user needs when the second device 102 is eligible (namely, passing verification) and the lock 104 is unlocked. It prevents the lock 104 from being unlocked when the user is still far, thereby ensuring security.

Besides, the wireless communication connection preferably complies with a Bluetooth protocol, but is not limited to this. Any communication technology (such as WIFI, ZigBee, 3G, 4G communication technology, and so on) capable of establishing a wireless communication connection with multiple channels may be adopted in the present invention. As known to those skilled in the art, the Bluetooth protocol uses 79 channels. In such a situation, when the wireless communication connection between the first device 100 and the second device 102 conforms to the Bluetooth protocol, the first device 100 and the second device 102 select specific channels from the 79 channels of the Bluetooth protocol as unlocking credential, and utilize Channel ID data as determination basis or determination credential (to determine whether to unlock or not). For example, in an embodiment, the predefined channels CH_x to CH_y of the first device 100 may be 1^{st}, 5^{th}, 8^{th}, 23^{rd}, 28^{th} channels of the Bluetooth protocol. Suppose that corresponding Channel ID data are CH_1, CH_5, CH_8, CH_23, and CH_28. After the second device 102 establishes the wireless communication connection with the first device 100 via the channels CH_a to CH_b, if the first device 100 determines Channel ID data of the channels CH_a to CH_b is CH_1, CH_5, CH_8, CH_23, CH_28, which conform to Channel ID data of the predefined channels CH_x to CH_y, the first device 100 unlocks the lock 104. On the contrary, if the first device 100 determines the Channel ID data of the channels CH_a to CH_b are CH_1, CH_6, CH_21, CH_29, which fail to conform to the Channel ID data of the predefined channels CH_x to CH_y, the first device 100 does not unlock the lock 104. Briefly, in this embodiment, it is necessary for the Channel ID data of the channels CH_a to CH_b to completely conform to the Channel ID data of the predefined channels CH_x to CH_y, such that the first device 100 would unlock the lock 104. This increases security.

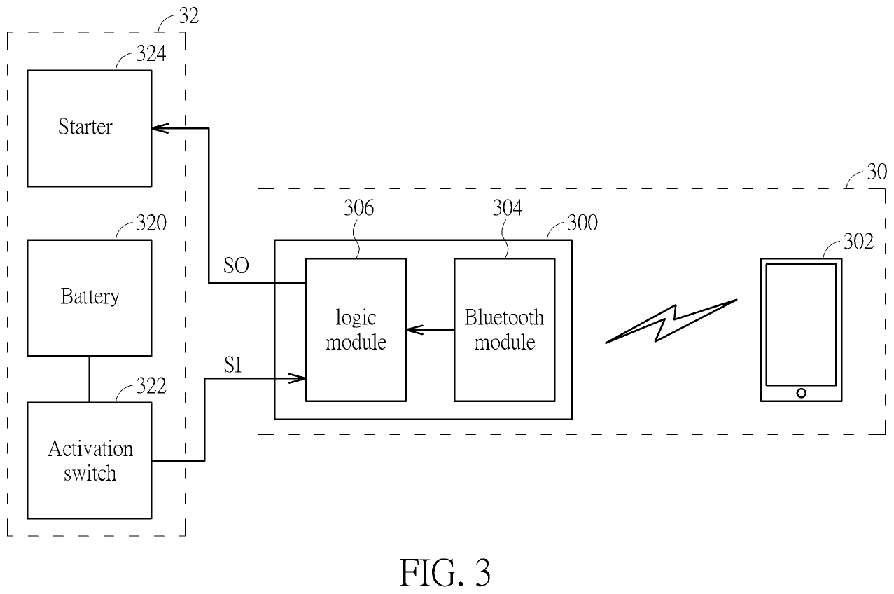

To perform the wireless communication connection, the first device 100 and the second device 102 should respectively include necessary components (such as antenna, radio frequency circuits, baseband processing modules, and so on) for establishment of the wireless communication connection. This is well known to those skilled in the art, and is not narrated hereinafter. Meanwhile, when it is necessary to adapt the wireless control process 20 according to an embodiment of the present invention in a specific structure, those skilled in the art may make appropriate modification of related software or hardware to execute related steps. Moreover, the wireless control system 10 may be utilized as a secondary or auxiliary authentication mechanism. For example, when applied in house access control management, the wireless control system 10 may work with fingerprint authentication to perform unlocking. In other words, a user would be required to carry the second device 102 to pass verification of the first device 100 and simultaneously utilize fingerprint(s) to perform unlocking, so as to pass access control and complete unlocking. Furthermore, when applied in vehicles, a car door lock may be controlled as how the lock 104 is manipulated. In addition, further appropriate modification may be done on the auxiliary authentication mechanism to make an engine start. For example, please refer to FIG. 3, which is a schematic diagram of a vehicle anti-theft system 30 according to an embodiment of the present invention. The vehicle anti-theft system 30 is utilized in a vehicle 32, and is derived from the wireless control system 10. The vehicle anti-theft system 30 includes a central control device 300 and a portable electronic device 302, which correspond to the first device 100 and the second device 102 of the wireless control system 10 respectively. The central control device 300 includes a Bluetooth module 304 and a logic module 306. The Bluetooth module 304 is able to establish a Bluetooth connection with the portable electronic device 302 and to transmit related information to the logic module 306. The logic module 306 is able to determine whether to activate the vehicle 32 accordingly. For the sake of simplicity, FIG. 3 only shows a battery 320, an activation switch 322 and a starter 324 of the vehicle 32. Operations of the vehicle anti-theft system 30 to activate the vehicle 32 are detailed as follows.

Specifically, after a user enters the vehicle 32 (by utilizing a key or the portable electronic device 302 to unlock a car door), the user enables connection between the battery 320 and the logic module 306 via the activation switch 322 (for example, by rotating a key or pressing an activation button). Then, the battery 320 outputs an activation signal SI to the logic module 306 to start up the Bluetooth module 304 and the logic module 306. At this moment, the portable electronic device 302 is controlled by the user (for instance, by executing an application) or automatically tries to establish a Bluetooth connection with the Bluetooth module 304 because the Bluetooth module 304 is detected. According to the embodiment of the present invention, if the portable electronic device 302 has already passed verification, the portable electronic device 302 establishes the Bluetooth connection with the Bluetooth module 304 via specific channels, and the Bluetooth module 304 transmits related information to the logic module 306. When the logic module 306 determines channels utilized by the portable electronic device 302 conform to the predefined channels, the logic module 306 outputs a start signal SO to the starter 324, so as to initiate an engine and start the vehicle 32. On the contrary, if the portable electronic device 302 does not pass verification, the logic module 306 does not output the start signal SO, and the vehicle 32 remains in an off state.

Therefore, in the vehicle anti-theft system 30, the portable electronic device 302 may be utilized as an unlocking tool, and utilize channels (via which the Bluetooth connection may be established) for verification so as to increase a detecting distance and ensure security. Besides, similar to the wireless control system 10, the vehicle anti-theft system 30 also configures information such as predefined channels, a distance between the portable electronic device 302 and the central control device 300, and so on, and is not detailed redundantly.

In summary, the present invention utilizes channels of wireless communication connection as authentication credential, thereby effectively increasing a detecting distance to increase convenience and security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless control method, for a first device and a second device, the wireless control method comprising:
the second device establishing a wireless communication connection with the first device via a plurality of channels;
the first device determining whether the plurality of channels conform to a plurality of predefined channels; and
the first device executing a function when the plurality of channels conform to the plurality of predefined channels.

2. The wireless control method of claim 1, further comprising the second device establishing another wireless communication connection with the first device first before the second device establishing the wireless communication connection with the first device via the plurality of channels, wherein channels utilized in the another wireless communication connection are different from the plurality of channels.

3. The wireless control method of claim 1, wherein the second device executes an application, to activate establishing the wireless communication connection with the first device via the plurality of channels.

4. The wireless control method of claim 1, wherein the wireless communication connection conforms to a Bluetooth protocol.

5. The wireless control method of claim 1, further comprising:
the first device not executing the function when the plurality of channels do not conform to the plurality of predefined channels.

6. The wireless control method of claim 1, further comprising configuring the plurality of predefined channels via the first device.

7. The wireless control method of claim 1, wherein the first device starts to determine whether the plurality of channels conform to the plurality of predefined channels when signal strengths of the plurality of channels are greater than a predefined value.

8. The wireless control method of claim 7, further comprising configuring the predefined value.

9. The wireless control method of claim 1, wherein the second device is a portable handheld device.

10. The wireless control method of claim 1, wherein executing the function is unlocking a lock.

11. A wireless control system, comprising:
a first device; and
a second device;
wherein the second device establishes a wireless communication connection with the first device via a plurality of channels; the first device determines whether the plurality of channels conform to a plurality of predefined channels; and the first device executes a function when the plurality of channels conform to the plurality of predefined channels.

12. The wireless control system of claim 11, wherein the second device establishes another wireless communication connection with the first device first before the second device establishes the wireless communication connection with the first device via the plurality of channels, and channels utilized in the another wireless communication connection are different from the plurality of channels.

13. The wireless control system of claim 11, wherein the second device executes an application, to activate establishing the wireless communication connection with the first device via the plurality of channels.

14. The wireless control system of claim 11, wherein the wireless communication connection conforms to a Bluetooth protocol.

15. The wireless control system of claim 11, wherein the first device does not execute the function when the plurality of channels do not conform to the plurality of predefined channels.

16. The wireless control system of claim 11, wherein the first device starts to determine whether the plurality of channels conform to the plurality of predefined channels when signal strengths of the plurality of channels are greater than a predefined value.

17. The wireless control system of claim 11, wherein the second device is a portable handheld device.

18. The wireless control system of claim 11, wherein executing the function is unlocking an access control of the first device.
